(19) United States
(12) Patent Application Publication
(10) Pub. No.: US 2012/0034503 A1
(43) Pub. Date: Feb. 9, 2012

(54) POSITIVE ELECTRODE MATERIAL FOR LITHIUM-ION SECONDARY BATTERY, LITHIUM-ION SECONDARY BATTERY AND SECONDARY BATTERY MODULE USING THE SAME

(75) Inventors: Tatsuya TOYAMA, Hitachi-shi (JP); Kazushige KOHNO, Hitachi-shi (JP)

(73) Assignee: Hitachi, Ltd.

(21) Appl. No.: 13/195,881

(22) Filed: Aug. 2, 2011

(30) Foreign Application Priority Data
Aug. 6, 2010 (JP) 2010-176901

(51) Int. Cl. H01M 4/50; H01M 2/10; H01M 10/48; H01M 4/52

(52) U.S. Cl. 429/91; 429/223; 429/224; 429/156

(57) ABSTRACT

A positive electrode material for a lithium-ion secondary battery that can stably inhibit heat generation, a lithium-ion secondary battery comprising the positive electrode material for a lithium-ion secondary battery as a positive electrode material that is excellent in safety during charging, and a secondary battery module using the lithium-ion secondary battery are provided. The positive electrode material for a lithium-ion secondary battery of the present invention is characterized in that:
a coating layer comprising a phosphate compound and an oxide or fluoride containing A (where A denotes at least one element selected from the group consisting of Mg, Al, Ti, and Cu) is formed on a layered lithium-manganese composite oxide represented by the following formula: LiMnₓM₁₋ₓO₂ (where 0.1≦x≦0.6 and M denotes at least one element selected from the group consisting of Li, Mg, Al, Ti, Co, Ni, and Mo); and
the atomic concentration of phosphorus on the outer side of the coating layer is greater than that on the lithium-manganese composite oxide side of the coating layer.

### BACKGROUND OF THE INVENTION

1. Field of the Invention

The present invention relates to a lithium-ion secondary battery.

2. Background Art

Among secondary batteries, lithium-ion secondary batteries using lithium ions are characterized in that lithium is highly likely to be ionized, the atomic weight of lithium is small, and the mass/weight energy density of lithium is high. Therefore, lithium-ion secondary batteries are widely used as power sources for commercially available equipments such as cell phones, notebook computers, and PDAs (personal digital assistants). In addition, for the future, lithium-ion secondary batteries are expected to be developed as power sources for eco-friendly electric vehicles (motor-driven vehicles) with reduced CO₂ emissions and hybrid vehicles which are driven by motors and engines and as power storage batteries for renewable energy generated via solar power generation, wind power generation, or the like. In the fields related to the use of such large-type lithium-ion secondary batteries, it is strongly required to for large-type lithium-ion secondary batteries to have improved safety and capacity compared with power sources for commercially available equipments.

At present, layered lithium composite oxides such as lithium cobalt oxide and lithium nickel oxide are mainly used as positive electrode materials for lithium-ion secondary batteries. However, these materials are unstable in terms of thermostability during charging, which is problematic for safety upon heavy use. In a case in which a layered lithium composite oxide is used, the crystalline structure thereof varies when temperature increases during charging, resulting in desorption of oxygen. The desorbed oxygen reacts with an electrolyte solution to induce a heat generation reaction. Therefore, in order to stabilize the crystalline structure in which lithium is partially reduced as a result of charging, it is a common technique to partially substitute cobalt or nickel with a different type of element as described in JP Patent No. 3244314. However, thermostability cannot be sufficiently improved by substitution with a small amount of an element. Meanwhile, if substitution of a large amount of an element is carried out, it results in reduction of battery capacity, which is problematic.

Reduction of battery capacity is caused by a valence change in a transition metal in a positive electrode material as a result of element substitution. Therefore, in order to improve thermostability while maintaining battery capacity, a technique for coating the positive electrode material surface with a different type of compound can be used. For example, in JP Patent Publication (Kokai) No. 2004-319129 A, the surface of a layered lithium composite oxide is coated with an inorganic compound or a carbon material. As a result of such coating, oxidative degradation of an electrolyte solution can be inhibited even at high voltages. This leads to the improvement of thermostability. In addition, in JP Patent Publication (Kokai) No. 2009-245917 A, Al-containing oxide and/or Al-containing hydroxide are uniformly distributed on the positive electrode material surface such that projections are formed thereon. In addition, a phosphate compound is attached to the surface. Accordingly, degradation of a non-aqueous electrolyte solution and elution of elements such as cobalt from a positive electrode material can be inhibited. In particular, a phosphate compound is effective to inhibit elution of elements from a positive electrode material. An example in which a phosphate compound is distributed in the vicinity of a positive electrode material and the outer surface of the material is coated with an Al compound is described in JP Patent Publication (Kokai) No. 2009-245917 A.

### SUMMARY OF THE INVENTION

An object of the present invention is to optimize the distribution of a coating compound in view of the role of the compound used for coating of a layered lithium-manganese composite oxide so as to improve coating effects. Another object of the present invention is to provide a lithium-ion secondary battery that is excellent in safety with the use of a surface-coated lithium-manganese composite oxide that is excellent in thermostability during charging as a positive electrode material.

In order to achieve the above object, the present invention is described as below. In a first aspect of the present invention, a positive electrode material for a lithium-ion secondary battery is characterized in that a coating layer comprising a phosphate compound and an oxide or fluoride containing A (where A denotes at least one element selected from the group consisting of Mg, Al, Ti, and Cu) is formed on the surface of a lithium-manganese composite oxide, and the atomic concentration of P in the phosphate compound on the outer side (i.e., the electrolyte side) of the coating layer is greater than that on the lithium-manganese composite oxide side of such layer.

In a second aspect of the present invention, a lithium-ion secondary battery comprises the positive electrode material for a lithium-ion secondary battery according to the first aspect of the present invention.

In a third aspect of the present invention, a lithium-ion secondary battery module comprises a plurality of electrically connected lithium-ion secondary batteries according to the second aspect of the present invention and a controller for detecting inter-terminal voltages of and controlling conditions of the plurality of lithium-ion secondary batteries.

In a forth aspect of the present invention, a lithium-ion secondary battery module is a secondary battery module comprising a plurality of electrically connected batteries and a controller for regulating and controlling conditions of the plurality of batteries, wherein:

the controller detects inter-terminal voltages of the plurality of batteries;

each battery is composed of at least one laminate having a positive electrode, a negative electrode, and an electrolyte housed in a battery can serving as an exterior package of the battery;

the positive electrode comprises a lithium-manganese composite oxide, on the surface of which a coating layer comprising a phosphate compound and an oxide or fluoride containing A (where A denotes at least one element selected from the group consisting of Mg, Al, Ti, and Cu) is formed; and

the atomic concentration of P in the phosphate compound on the outer side (i.e., the electrolyte side) of the coating layer is greater than that on the lithium-manganese composite oxide side of such layer.

### EFFECTS OF THE INVENTION

According to the present invention, a positive electrode material for a lithium-ion secondary battery having excellent thermostability even at high voltages, a lithium-ion secondary battery that is excellent in safety during charging in which the positive electrode material for a lithium-ion secondary battery is used as a positive electrode material, and a secondary battery module using the lithium-ion secondary battery can be realized.

### BRIEF DESCRIPTION OF THE DRAWINGS

FIG. 1 schematically shows a longitudinal section of a lithium-ion secondary battery used in one embodiment of the present invention.

FIG. 2 shows an X-ray diffraction pattern of a positive electrode material obtained in one embodiment of the present invention.

FIG. 3 is a chart showing the distributions of major elements in the vicinity of the coating layer of a positive electrode material obtained in one embodiment of the present invention.

FIG. 4 shows an electron diffraction image of a coating compound containing Al used for a positive electrode material obtained in one embodiment of the present invention.

FIG. 5 shows an electron diffraction image of a coating compound containing P used for a positive electrode material obtained in one embodiment of the present invention.

FIG. 6 shows the outline of a secondary battery system equipped with lithium-ion secondary batteries produced in one embodiment of the present invention.

### DESCRIPTION OF THE PREFERRED EMBODIMENTS

Features of the positive electrode material for a lithium-ion secondary battery, the lithium-ion secondary battery, and the secondary battery module of the present invention are described below.

The positive electrode material for a lithium-ion secondary battery of the present invention is characterized in that a coating layer comprising a phosphate compound and an oxide or fluoride containing A (where A denotes at least one element selected from the group consisting of Mg, Al, Ti, and Cu) is formed on the surface of a layered lithium-manganese composite oxide for a positive electrode material, and that the atomic concentration of P in the phosphate compound on the outer side (i.e., the electrolyte side) of the coating layer is greater than that on the lithium-manganese composite oxide side of such layer. Here, it is possible to uniformly coat the lithium-manganese composite oxide surface with an oxide or fluoride containing A, while on the other hand, it is difficult to uniformly coat the surface with a phosphate compound alone. Therefore, an oxide or fluoride containing A is added to facilitate uniform distribution of a phosphate compound on the lithium-manganese composite oxide surface. As a result of formation of a coating layer having such configuration, a phosphate compound that is highly effective to inhibit oxidative degradation of an electrolyte solution is allowed to function to a maximum extent. Accordingly, thermostability can be improved.

The lithium-ion secondary battery of the present invention is a lithium-ion secondary battery in which a positive electrode capable of intercalating/de-intercalating lithium ions (Li⁺) and a negative electrode capable of intercalating/de-intercalating lithium ions (Li⁺) are formed via an electrolyte, such lithium-ion secondary battery being characterized in that a positive electrode comprises a layered lithium-manganese composite oxide, a coating layer comprising a phosphate compound and an oxide or fluoride containing A (where A denotes at least one element selected from the group consisting of Mg, Al, Ti, and Cu) is formed on the surface of the lithium-manganese composite oxide, and the atomic concentration of P in the phosphate compound on the outer side (i.e., the electrolyte side) of the coating layer is greater than that on the lithium-manganese composite oxide side of such layer.

Preferably, the lithium-manganese composite oxide is represented by the following composition formula: LiMnₓM₁₋ₓO₂ (where 0.1≦x≦0.6 and M denotes at least one element selected from the group consisting of Li, Mg, Al, Ti, Co, Ni, and Mo).

Preferably, a phosphate compound that constitutes the coating layer is at least one member selected from the group consisting of Li₃PO₄, Li₄P₂O₇, and LiPO₃. The content of the phosphate compound is preferably 0.1% by weight to 5.0% by weight relative to the content of the lithium-manganese composite oxide (when the content of the lithium-manganese composite oxide is 100% by weight).

In addition, the content of an oxide or fluoride containing A and forming the coating layer is preferably 0.2% by weight to 1.5% by weight relative to the content of the lithium-manganese composite oxide (when the content of the lithium-manganese composite oxide is 100% by weight).

Further, the thickness of the coating layer formed on the surface of the lithium-manganese composite oxide used for a positive electrode material is preferably 2 nm to 80 nm.

Furthermore, the lithium-ion secondary battery of the present invention is characterized in that, when the positive electrode charged to 4.8 V by a Li counter electrode is heated, the main exothermic peak becomes 230° C. or higher.

The secondary battery module of the present invention is a secondary battery module comprising a plurality of electrically connected batteries and a controller for regulating and controlling conditions of the plurality of batteries, wherein:

the controller detects inter-terminal voltages of the plurality of batteries;

each battery is composed of at least one laminate having a positive electrode, a negative electrode, and an electrolyte housed in a battery can;

the positive electrode comprises a lithium-manganese composite oxide, on the surface of which a coating layer comprising a phosphate compound and an oxide or fluoride containing A (where A denotes at least one element selected from the group consisting of Mg, Al, Ti, and Cu) is formed; and

the atomic concentration of P in the phosphate compound on the outer side (i.e., the electrolyte side) of the coating layer is greater than that on the lithium-manganese composite oxide side of such layer.

Next, one embodiment for carrying out the present invention is described below in detail.

### <The Configuration of Lithium-Ion Secondary Battery 10>

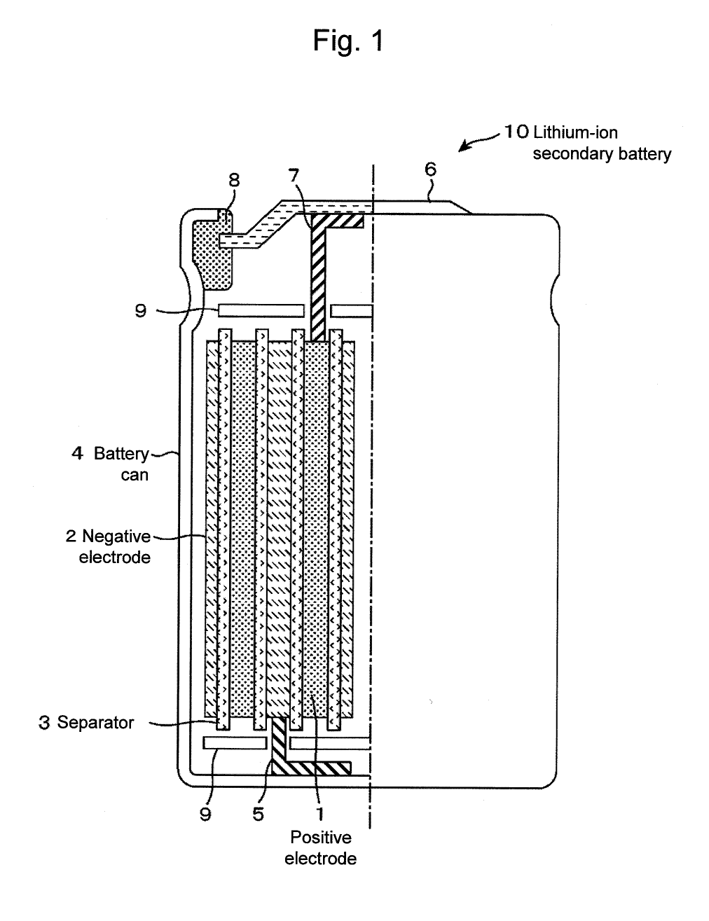

FIG. 1 schematically shows a longitudinal section of a lithium-ion secondary battery 10 (a 18650-type lithium-ion secondary battery).

A lithium-ion secondary battery 10 comprises a positive electrode 1, a negative electrode 2, and a separator 3 that is a fine porous thin film or the like having ion conductivity and prevents a contact between the positive electrode 1 and the negative electrode 2. The positive electrode 1, the negative electrode 2, and the separator 3 are layered, spirally coiled, and introduced into a stainless-steel or aluminium battery can 4 containing a non-aqueous electrolyte solution comprising an organic solvent. Then, the can is tightly sealed.

A positive electrode lead 7 is formed on the positive electrode 1 for current collection. Meanwhile, a negative electrode lead 5 is formed on the negative electrode 2 for current collection. Accordingly, a current generated by the positive electrode 1 and a current generated by the negative electrode 2 are collected by means of the positive electrode lead 7 and the negative electrode lead 5, respectively.

An insulating plate 9 comprising an insulative material such as an epoxy resin is formed between the positive electrode 1 and the negative electrode lead 5 and between the negative electrode 2 and the positive electrode lead 7 in order to prevent short circuit. In addition, a packing 8 (seal material) comprising an electrically insulative material such as rubber is formed between a battery can 4 in contact with the negative electrode lead 5 and a cover 6 in contact with the positive electrode lead 7 in order to prevent leakage of the electrolyte solution and separate the positive electrode 1 (positive pole) and the negative electrode 2 (negative pole).

### <Positive Electrode 1>

The positive electrode 1 is formed by applying a positive electrode mixture to a current collector formed with aluminium, copper, or the like (e.g., aluminum foil with a thickness of 5 μm to 25 μm or copper foil with a thickness of approximately 10 μm) to a thickness of approximately 100 μm for each side. The positive electrode mixture comprises an active material for promoting intercalation/de-intercalation of lithium described below, a conductive material for improving conductivity of the positive electrode 1, a binder comprising PVDF (polyvinylidene difluoride) or the like for ensuring adhesion to a current collector, and the like.

### <Negative Electrode 2>

The negative electrode 2 is formed by applying a negative electrode mixture to a current collector formed with copper or the like (e.g., copper foil with a thickness of 7 μm to 20 μm) to a thickness of approximately 100 μm for each side. The negative electrode mixture comprises an active material, a conductive material, a binder, and the like. An active material that can be used for the negative electrode 2 may be metal lithium, a carbon material, or a material into which lithium can be intercalated or which can form a compound with lithium. However, a carbon material is particularly preferable. Examples of such carbon material include: graphites such as natural graphite and artificial graphite; and amorphous carbons such as coal coke, carbide of coal pitch, petroleum coke, carbide of petroleum pitch, and carbide of pitch coke.

Preferably, the above carbon materials are subjected to surface treatment in different ways. It is possible to use one member or a combination of two or more members selected from among the carbon materials.

Examples of a material into which lithium ions (Li⁺) can be intercalated or which can form a compound with lithium include: metals such as aluminium, tin, silicon, indium, gallium, and magnesium; alloys comprising such elements; and metal oxides comprising tin, silicon, and the like. Further, a composite comprising such metal, alloy, or metal oxide and a carbon material such as graphite or amorphous carbon can be used.

### <A Coating Layer Covering a Lithium-Manganese Composite Oxide Used for a Positive Electrode 1>

It is preferable to use, as an active material for a positive electrode 1, a positive electrode material in which a coating layer comprising a phosphate compound and an oxide or fluoride containing A (where A denotes at least one element selected from the group consisting of Mg, Al, Ti, and Cu) is formed on the surface of a lithium-manganese composite oxide, and the atomic concentration of P in the phosphate compound on the outer side (i.e., the electrolyte side) of the coating layer is greater than that on the lithium-manganese composite oxide side of such layer.

A phosphate compound functions to inhibit oxidative degradation of an electrolyte solution in the vicinity of a positive electrode at high voltages. Even when coating is performed using a phosphate compound alone, such inhibition effects can be exhibited. However, when a phosphate compound is used with an oxide or fluoride containing A (where A denotes at least one element selected from the group consisting of Mg, Al, Ti, and Cu) and the compound and the oxide or fluoride are optimally distributed in the coating layer, the inhibition effects can be significantly improved. Preferably, the atomic concentration of P in the phosphate compound on the outer side (i.e., the electrolyte side) the coating layer is greater than that on the composite oxide side of such layer.

The element A contained in the coating layer is Mg, Al, Ti, or Cu. The composite oxide surface can be uniformly coated with a thin film comprising an oxide or fluoride of Mg, Al, Ti, or Cu. It is possible to selectively distribute the element A in the vicinity of the composite oxide in the coating layer. In addition, although it is difficult to coat the composite oxide surface with a phosphate compound alone, it becomes possible to uniformly distribute a phosphate compound on the composite oxide surface by further coating the thin film with a phosphate compound.

The oxide or fluoride containing A (where A denotes at least one element selected from the group consisting of Mg, Al, Ti, and Cu) also functions to inhibit oxidative degradation of an electrolyte solution in the vicinity of a positive electrode at high voltages. However, such inhibition effects are weaker than those provided by the phosphate compound. Therefore, unlike the distribution of the phosphate compound, the atomic concentration of A on the composite oxide side of the coating layer is preferably greater than that on the outer side (i.e., the electrolyte side) of such layer.

In order to achieve the above distribution in the coating layer, the coating layer is divided into two sides at the center of the thickness of the layer. Specifically, the length from the interface between one face of the coating layer and the composite oxide to the interface between the other face of the coating layer and the electrolyte solution (electrolyte) is halved. The side of the interface between one face of the coating layer and the composite oxide that constitutes a positive electrode material is designated as the composite oxide side. The side of the interface between the other face of the coating layer and the electrolyte solution (electrolyte) is designated as the outer side (i.e., the electrolyte side). The term “atomic concentration” used herein refers to the mean value of the concentration for each divided section. Here, in view of measurement errors, it is defined that when the atomic concentration is high, the mean value of the atomic concentration on the outer side (i.e., the electrolyte side) is greater by at least 4 atom % than the mean value of the atomic concentration on the composite oxide side.

In terms of inhibition of oxidative degradation of the electrolyte solution described above, the phosphate compound forming a coating layer is preferably at least one member selected from the group consisting of Li₃PO₄, Li₄P₂O₇, and LiPO₃.

As the lithium-manganese composite oxide, a composite oxide represented by the following composition formula is preferably used: LiMnₓM₁₋ₓO₂ (where 0.1≦x≦0.6 and M denotes at least one element selected from the group consisting of Li, Mg, Al, Ti, Co, Ni, and Mo). LiMnₓM₁₋ₓO₂ has a hexagonal crystal layered structure. In the case of the hexagonal crystal layered structure, the lithium diffusion pathway is two-dimensionally formed in a space inside a crystal lattice. Meanwhile, in the case of the orthorhombic olivine structure represented by LiFePO₄, the lithium diffusion pathway is one-dimensionally formed in a space inside a crystal lattice. Accordingly, in the case of LiMnₓM₁₋ₓO₂, the lithium diffusion pathway is a two-dimensional network. Thus, LiMnₓM₁₋ₓO₂ has high Li conductivity, which is advantageous.

A transition metal is responsible for charge compensation upon intercalation/de-intercalation of Li. Preferably, Mn is contained as a transition metal. A transition metal becomes a tetravalent compound when complete de-intercalation of Li takes place during charging. However, tetravalent Mn is stable and thus the crystalline structure is stably maintained even during charging. Note that when the stoichiometric coefficient of Mn is less than 0.1, Mn cannot contribute to stabilization of the structure. Meanwhile, when it exceeds 0.6, it becomes difficult for the layered structure itself to be maintained. Therefore, the stoichiometric coefficient of Mn “x” is preferably 0.1≦x≦0.6 and more preferably 0.2≦x≦0.4.

Examples of a transition metal include Ti, V, Cr, Fe, Co, Ni, Cu, Nb, and Mo, in addition to Mn. However, an element that forms a layered composite oxide with lithium is preferably Ti, Ni, Co, or Mo.

In addition, it is known that the lithium diffusion pathway is inhibited by site (position) exchange between lithium and a transition metal in a layered positive electrode material, which results in reduction of lithium ion (Li⁺) conductivity. In such case, site exchange between lithium and a transition metal can be inhibited via partial substitution of a transition metal with a typical element that is stable in terms of valence. In the present invention, the rate of site (position) exchange between lithium and a transition metal can be reduced particularly with the use of monovalent lithium, divalent magnesium, and trivalent aluminium as substitution elements.

The stoichiometric coefficient of oxygen (O) is designated as 2. It is known that the stoichiometric composition would slightly vary depending on calcination conditions. Therefore, the stoichiometric coefficient of oxygen may increase or decrease by approximately 5% within the scope of the present invention.

In order to obtain a composite oxide having excellent thermostability during charging, the content of a coating compound forming a coating layer is an important factor, as well as the distribution of the coating compound (i.e., the coating layer) covering a composite oxide and the composition of the composite oxide.

The content of a phosphate compound constituting the coating compound (i.e., the coating layer) is 0.1% by weight to 5.0% by weight relative to that of a composite oxide used for a positive electrode material (when the content of the composite oxide is 100% by weight).

The phosphate compound forming a coating layer functions to inhibit oxidative degradation of an electrolyte solution. If the content of the phosphate compound is less than 0.1% by weight, the composite oxide surface cannot be entirely covered. In such case, the compound cannot sufficiently function as described above. Meanwhile, when it exceeds 5.0% by weight, the phosphorus compound itself does not contribute to a charge-discharge reaction, causing reduction of battery capacity. Therefore, the above content is more preferably 0.5% by weight to 2.0% by weight, which falls within a median range between the above values.

The content of an oxide or fluoride containing M (where M denotes at least one element selected from the group consisting of Mg, Al, and Cu) constituting the coating compound (i.e., the coating layer) is preferably 0.2% by weight to 1.5% by weight relative to the content of the composite oxide (when the content of a composite oxide is 100% by weight).

Here, an oxide or fluoride containing M functions to serve as an interposed layer that facilitates coating of the entire surface of a composite oxide with a phosphate compound. Therefore, it preferably covers the entire surface of a composite oxide. Accordingly, when the content of an oxide or fluoride containing M is less than 0.2% by weight, the amount thereof is insufficient and thus it cannot be said that the amount is sufficient to coat the composite oxide surface. Meanwhile, when the content exceeds 1.5% by weight, it results in an increase in positive electrode resistance that causes an increase in electric power loss because an oxide or fluoride containing M itself is an insulative material. This leads to significant reduction of battery capacity. Therefore, the above content is more preferably 0.4% by weight to 1.0% by weight, which falls within a median range between the above values.

In addition, the thickness of a coating layer covering a composite oxide is preferably 2 nm to 80 nm. When the coating layer thickness is less than 2 nm, it is necessary to specify the diameter of a coating compound particle to be smaller than the thickness. In such case, van der Waals interaction causes aggregation of coating compound particles that form a coating layer, making it difficult to uniformly coat the composite oxide surface. Meanwhile, when the coating layer thickness exceeds 80 nm, it results in a significant increase in resistance in the coating layer that causes an increase in electric power loss rather than the improvement of thermostability during charge. This leads to reduction of battery characteristics. The thickness is more preferably 10 nm to 60 nm, which falls within a median range between the above values.

<Surface Coating Treatment Via Formation of a Coating Layer with a Composite Oxide>

Surface coating treatment is necessary for the formation of a coating compound (i.e., a coating layer) on the composite oxide surface. According to the present invention, a coating compound contains a phosphate compound and an oxide or fluoride containing A (where A denotes at least one element selected from the group consisting of Mg, Al, Ti, and Cu).

In addition, it is necessary for the atomic concentration of P in the phosphate compound contained in the coating compound on the outer side (i.e., the electrolyte side) of the coating layer to be greater than that on the composite oxide side of such layer. Therefore, the procedure of coating treatment of a composite oxide is important.

Surface treatment techniques using composite oxides can be roughly divided into solid-phase methods and liquid-phase methods. However, liquid-phase methods are preferable. According to solid-phase methods, it is difficult to cause uniform dispersion of a coating compound (forming a coating layer) on the composite oxide surface. In addition, there is concern that physical damage of the composite oxide surface might be caused by coating treatment. Meanwhile, liquid phase methods are advantageous in that the composite oxide surface can be uniformly covered, that the coating layer particle diameter can be controlled, and that the composite oxide surface is less likely to be physically damaged.

A composite oxide was coated in the manner described below in order to increase the atomic concentration of P in the phosphate compound in the vicinity of the outer side (i.e., the electrolyte side) of the coating layer.

In addition, a hydroxide containing A was generated in a solvent and mixed with a composite oxide. Then, a phosphate compound was introduced into the solvent and mixed therein at room temperature. As a result of mixing in such manner, a hydroxide comprising water molecules attaches in advance to the composite oxide surface. At such time, the hydroxide comprises OH groups and thus the wettability is high. Therefore, the hydroxide can readily adhere to the composite oxide surface. Thereafter, a phosphate compound adheres to the hydroxide. The resultant is dried in vacuo or subjected to spray drying to evaporate the solvent. The thus obtained powder is subjected to heat treatment in the air. Accordingly, an oxide containing A can be obtained from the hydroxide containing A.

Alternatively, if heat treatment is performed in a fluorine gas atmosphere, a fluoride containing A can be obtained from a hydroxide containing A. As a result of such treatment, the atomic concentration of P in the phosphate compound can be increased in the vicinity of the outer side (i.e., the electrolyte side) of the coating layer. Meanwhile, the atomic concentration of A in the vicinity of the composite oxide tends to be greater than that on the outer side (i.e., the electrolyte side).

It is possible to use only a positive electrode material for a lithium-ion secondary battery in which a coating layer comprising a phosphate compound and an oxide or fluoride containing A (where A denotes at least one element selected from the group consisting of Mg, Al, Ti, and Cu) is formed on the surface of a lithium-manganese composite oxide, and the atomic concentration of P in the phosphate compound on the outer side (i.e., the electrolyte side) of the coating layer is greater than that on the lithium-manganese composite oxide side of such layer. Alternatively, such positive electrode material for a lithium-ion secondary battery may be mixed with a non-coated composite oxide or a positive electrode material having a spinel structure or an olivine structure. The obtained mixture can be used in the present invention.

The lithium-ion secondary battery of the present invention is characterized in that, when the positive electrode charged to 4.8 V by a Li counter electrode is heated, the main exothermic peak becomes 230° C. or higher and preferably 250° C. or higher.

### <A Method for Producing a Composite Oxide>

Next, a method for producing a composite oxide (lithium-manganese composite oxide) is described below.

The substances described below can be used as starting materials for a composite oxide.

Examples of a lithium compound that can be used include lithium carbonate (Li₂CO₃), lithium hydroxide (LiOH), lithium nitrate (LiNO₃), lithium acetate (CH₃CO₂Li), lithium chloride (LiCl), and lithium sulfate (Li₂SO₄). However, lithium carbonate (Li₂CO₃) and lithium hydroxide (LiOH) are preferable.

Examples of a manganese compound that can be used include manganese hydroxide (Mn(OH)₃), manganese carbonate (Mn₂(CO₃)₃), manganese nitrate (Mn(NO₃)₃), manganese acetate (Mn(CH₃CO₂)₃), manganese sulfate (Mn₂(SO₄)₃), and manganese oxide (MnO). However, manganese carbonate (Mn₂(CO₃)₃) and manganese oxide (MnO) are preferable.

Examples of a compound containing a substitution element M include hydroxide, carbonate, nitrate, acetate, sulfate, and oxide.

Substances used as starting materials are supplied in powder forms at predetermined compositions. The substances are pulverized in a mechanical manner using a ball mill or the like, followed by mixing. Pulverization and mixing can be carried out by a dry or wet method. The thus obtained powder is calcinated at 700° C. to 1000° C. and preferably 800° C. to 900° C. The time period for calcination is 4 to 48 hours and preferably 10 to 24 hours. Preferably, calcination is carried out in an oxidized gas (O₂) atmosphere containing oxygen or air. After calcination, air cooling may be performed. Alternatively, slow cooling in an inert gas (e.g., a nitrogen or argon gas) atmosphere or rapid cooling using liquid nitrogen or the like may be performed. Further, calcination may be repeatedly carried out at least twice.

Desorption of oxygen from the composite oxide surface can be inhibited in the above manner. The mean secondary particle diameter for the powder obtained after calcination is preferably 1 μm to 20 μm. If it is less than 1 μm, the specific surface area becomes excessively large, making it impossible to sufficiently secure the electron-conductive pathway upon electrode production. Meanwhile, if it exceeds 20 μm, the Li diffusion pathway in the composite oxide is extended. This is disadvantageous in terms of intercalation/de-intercalation of lithium. More preferably, it falls within a median range of the above values, which is from 4 μm to 15 μm.

Next, surface treatment is performed using the thus obtained composite oxide.

### <A Method for Surface Treatment of a Composite Oxide>

A method for surface treatment of a composite oxide (lithium-manganese composite oxide) according to a liquid phase method is described below.

A predetermined amount of nitrate, acetate, or sulfate containing a metal element selected from the group consisting of Mg, Al, Ti, and Cu is dissolved in an organic solvent. Then, the pH of the solvent is adjusted to the pH of the composite oxide (lithium-manganese composite oxide) using a pH adjuster. Here, the pH of the composite oxide corresponds to the pH of a supernatant obtained by adding a composite oxide (10 g) to pure water (100 ml), stirring the resultant at room temperature for 10 minutes, and allowing the resultant to stand still for 20 minutes. The pH of the composite oxide differs depending on the composition thereof. However, it is approximately pH 8 to pH 11. As a pH adjuster, an alkaline solution such as lithium hydroxide (LiOH) or ammonia (NH₃) water can be used. However, it is preferable to use lithium hydroxide (LiOH). The pH of the composite oxide is adjusted with an error of approximately ±0.5 using lithium hydroxide to form an alkaline solution. Accordingly, a hydroxide metal is formed with a starting material comprising a metal element (e.g., nitrate, acetate, or sulfate containing a metal element selected from the group consisting of Mg, Al, Ti, and Cu) so as to precipitate therein.

For instance, the above positive electrode material is mixed with a solvent prepared by the following reaction so as to allow a coating compound to adhere to the surface of the material: Al(NO₃)₃+3H₂O Al(OH)₃+3HNO₃. Next, a predetermined amount of ammonium phosphate dibasic ((NH₄)₂HPO₄) or ammonium dihydrogen phosphate (NH₄H₂PO₄) serving as a starting material of a phosphate compound is dissolved in a solvent of the same type as that used above. Further, a predetermined amount of LiOH is added thereto. Accordingly, a phosphate compound is formed with a starting material (e.g., ammonium phosphate dibasic ((NH₄)₂HPO₄) or ammonium dihydrogen phosphate (NH₄H₂PO₄)) of a phosphate compound so as to precipitate therein.

For instance, a solvent obtained by the following reaction is added to a liquid mixture of a hydroxide metal and a composite oxide: (NH₄)₂HPO₄+3LiOH→Li₃PO₄+NO₃⁻+5H₂. Then, the solvent was evaporated. Preferably, the solvent is evaporated by heat stirring or spray drying. Eventually, the obtained powder is subjected to heat treatment at preferably 300° C. to 800° C. and more preferably 500° C. to 700° C. As a result of heating, an oxide (e.g., Al₂O₃) is formed from a hydroxide (e.g., Al(OH)₃) adhering to the composite oxide surface. Further, strong adhesion can be achieved between the coating compound (coating layer) and the composite oxide. The heating period is preferably 1 hour to 20 hours and more preferably 3 hours to 8 hours.

Alternatively, a fluoride (e.g., AlF₃) can be obtained from a hydroxide (e.g., Al(OH)₃) by carrying out heat treatment in a fluorine (F₂) gas atmosphere. Preferably, fluorine gas is nitrogen trifluoride (NF₃) gas.

### (Identification of a Crystalline Structure)

The crystalline structure of the produced composite oxide (lithium-manganese composite oxide) was determined based on a diffraction profile obtained by using an X-ray diffractometer (hereinafter abbreviated as “XRD”) (RINT-UltimaIII; Rigaku) with a radiation source (CuKα).

The crystalline structure of the composite oxide was identified based on the peak angle confirmed by the obtained diffraction profile.

### (A Method for Determining the Average Particle Size of a Positive Electrode Material)

The average particle size of a positive electrode material was determined using a laser scattering particle distribution analyzer (LA-920; Horiba Ltd.) by the laser diffraction/scattering method as described below.

First, a positive electrode material was added to a mixture obtained by mixing sodium hexametaphosphate (0.2% by weight) with pure water used as a dispersant. In order to prevent aggregation of the material, ultrasonication was carried out for 5 minutes for particle separation. Then, the median diameter (i.e., the particle diameter obtained when the relative particle mass accounts for 50%) was determined and designated as the average particle size.

### (Determination of the Distributions of Elements in a Coating Layer)

The coating layer thickness and the atomic concentration distribution in the coating layer were determined using a transmission electron microscope (hereinafter abbreviated as “TEM”) (HF-2000; Hitachi) equipped with an energy dispersive x-ray spectrometer (hereinafter abbreviated as “EDS”) (NORAN System 300; Thermo Fisher Scientific K.K.) at an acceleration voltage of 200 kV. A sample was sliced in advance using grinder (600-type; GATAN) by an Ar ion etching method.

In addition, the distributions of elements in the coating layer can be determined by TEM-EELS involving the combined use of TEM and electron energy loss spectroscopy (EELS), time-of-flight secondary ion mass spectrometry (TOF-SIMS), Auger electron spectroscopy (AES), or the like.

### (Identification of a Coating Compound (Coating Layer))

The binding state of the surface coating compound (coating layer) was examined by obtaining an electron diffraction image at an acceleration voltage of 200 kV using TEM (HF-2000; Hitachi) and comparing the obtained diffraction points with diffraction points of known compounds based on the information contained in the database of TEM so as to determine the compound type.

### (A Method for Determining the Weight Ratio of Elements)

The weight ratio of elements constituting the coating layer used for surface treatment was determined using high-frequency inductively coupled plasma (hereinafter referred to as “ICP”) analyzer (P-4000; Hitachi). First, a positive electrode material (5 g) and nitric acid (2 ml) were added to ion-exchange water (45 ml) contained in a beaker, followed by stirring with a stirrer for 30 minutes. The resultant was left for 5 minutes. The obtained extracted solution was filtrated with filter paper and sprayed with argon gas in a high-frequency atmosphere. The intensity of excitation light specific to each element was determined. Accordingly, the weight ratio of elements was calculated.

### (A Method for Determining the Exothermic Peak)

The calorific value determined upon temperature rising was evaluated using a differential scanning calorimeter (hereinafter abbreviated as “DSC”) (DSC6100; Seiko Instruments Inc.). First, initialization was carried out using a model cell for electrochemical characteristic evaluation. Then, a positive electrode charged to a predetermined voltage was produced, followed by punching (diameter: 4 mm) in a glove box in an argon atmosphere. Two positive electrodes obtained in such manner were placed in an SUS sample pan. An electrolyte solution (approximately 2 μl) was added thereto and the pan was tightly sealed using a swage. Then, a sample chamber was heated at 30° C. to 400° C. at a temperature rising rate of 5° C./min using a DSC apparatus in an argon atmosphere for exothermal behavior determination.

### <A Method for Producing a Lithium-Ion Secondary Battery>

An example of a method for producing a lithium-ion secondary battery is described below.

A positive electrode material (composite oxide) used as an active material is mixed with a conductive material (a carbon material powder) and a binder such as polyvinylidene difluoride so as to prepare slurry. The proportion of a conductive material mixed with a positive electrode material is preferably 3% by weight to 10% by weight (when the proportion of a positive electrode material is 100% by weight).

In addition, the proportion of a binder mixed with a positive electrode material is desirably 2% by weight to 10% by weight (when the proportion of a positive electrode material is 100% by weight).

Upon mixing, it is preferable to sufficiently knead a mixture using a kneader so as to uniformly disperse a positive electrode material in slurry.

The obtained slurry is applied to both sides of aluminum foil with a thickness of 15 μm to 25 μm serving as a current collector using, for example, a roll transcription machine. After coating of the both sides thereof, press drying is carried out to form an electrode plate used as a positive electrode 1 (see FIG. 1). The thickness of the mixture obtained by mixing a positive electrode material, a conductive material, and a binder is desirably 200 μm to 250 μm.

As in the case of the positive electrode, a negative electrode is formed by mixing a negative electrode material with a binder and applying the mixture to a current collector, followed by pressing. Here, the thickness of an electrode composite is desirably 20 μm to 70 μm. For the negative electrode, copper foil with a thickness of 7 μm to 20 μm is used as a current collector. For example, the weight ratio of the material and the binder to be mixed for coating is desirably 90:10.

The positive electrode and the negative electrode each obtained via coating with a mixture and pressing were cut into predetermined lengths. Thus, a positive electrode 1 and a negative electrode 2 are obtained as shown in FIG. 1. A positive electrode lead 7 and a negative electrode lead 5 are formed as current collecting tabs by spot welding or ultrasonic welding for the positive electrode and the negative electrode, respectively. Each of the positive electrode lead 7 and the negative electrode lead 5 serving as current collecting tabs is a member provided for current collecting from the relevant electrode that is composed of a rectangular current collector and metal foil of the same type. A separator 3 comprising polyethylene (PE), polypropylene (PP), or the like, which is an ion-conductive (L⁺-ion-permeable) fine porous film is sandwiched between the tab-welded positive electrode 1 and negative electrode 2. The obtained laminate is cylindrically (spirally) coiled as shown in FIG. 1 so as to form an electrode group. The obtained electrode group is housed in a battery can 4 which is a cylindrical container.

Alternatively, a separator in a pouch form may be used (not shown). Electrodes are housed in such separators. The separators are sequentially layered to form a multilayer structure and then housed in a square container. A material for the container is desirably stainless-steel or aluminum. If it is made of stainless-steel, a passivation film is formed on the surface thereof. Thus, corrosion is unlikely to take place. In addition, it has high strength because of steel properties. Such container can endure an increase in the pressure of a gas formed as a result of evaporation of an electrolyte solution or the like inside the battery can 4. Meanwhile, aluminum has light weight. Thus, it is characterized by high energy density per unit weight.

After an electrode group (consisting of the positive electrode 1, the negative electrode 2, and the separator 3) is housed in a battery can 4 serving as a battery container, the electrolyte solution is poured into the battery can 4 serving as a battery container and the battery can is tightly sealed with a packing 8. Thus, a battery is completed.

It is desirable to use, as the electrolyte solution, a solution obtained by dissolving an electrolyte such as lithium hexafluorophosphate (LiPF₆), lithium tetrafluoroborate (LiBF₄), or lithium perchlorate (LiClO₄) in a solvent such as diethyl carbonate (DEC), dimethyl carbonate (DMC), ethylene carbonate (EC), propylene carbonate (PC), vinylene carbonate (VC), methyl acetate (MA), ethyl methyl carbonate (EMC), or methyl propyl carbonate (MPC). The electrolyte concentration is preferably 0.7 M (mole) to 1.5 M (mole).

In addition, a compound having anhydrous carboxylate, a compound having a sulfuric element (S) such as propane sultone, or a compound having boron (B) may be mixed with the electrolyte solution. For instance, it is possible to add such compound in order to inhibit reductive degradation of the electrolyte solution on the surface of the negative electrode 2, to prevent reductive deposition of a metal element eluted from the positive electrode 1 (e.g., manganese) on the negative electrode 2, to improve ion conductivity of the electrolyte solution, or to achieve flame retardation of the electrolyte solution.

The present invention is hereafter described in greater detail with reference to the following examples, although the technical scope of the present invention is not limited thereto.

### Example 1

Table 1 shows properties of the composite oxide of the positive electrode produced in Example 1.

TABLE 1

| | | | | | | Atomic | | | |
|---|---|---|---|---|---|---|---|---|---|
| | | | | | Atomic | concentration | | Proportion | |
| | | | | Coating | concentration | of P on the | Proportion | of | |
| | | | | layer | of P on the | composite | of Li₃PO₄ | Compound | |
| Composite | LiMn_{X}M_{1-X}O₂ | | | thickness | outer side | oxide side | (% by | M (% by | Exothermic |
| oxide | x | M | A | (nm) | (atom %) | (atom %) | weight) | weight) | peak (° C.) |
| Example 1 | 0.2 | Li, Ni, | Al | 30 | 9 | 3 | 1 | 0.4 | 265 |
| | | Co | | | | | | | |

### (Production of a Positive Electrode Material)

In Example 1, lithium carbonate (LiCO₃), manganese oxide (MnO₂), nickel oxide (NiO), and cobalt oxide (CoO) were used as starting materials for a composite oxide. The starting materials were weighed at a ratio of Li:Mn:Ni:Co of 1.04:0.20:0.38:0.38, followed by wet pulverization using a pulverizer and mixing. The obtained powder was dried, introduced into a high-purity alumina container, and then subjected to preliminary calcination in the air at 600° C. for 10 hours to improve sintering performance, followed by air cooling. Next, the powder subjected to preliminary calcination was cracked and introduced again into a high-purity alumina container, followed by calcination in the air at 900° C. for 16 hours, air cooling, and cracking/sieving.

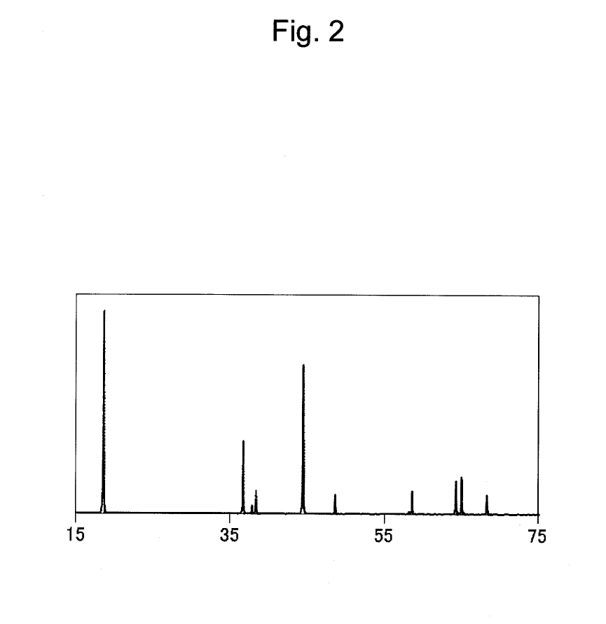

FIG. 2 shows the X-ray diffraction profile of the obtained composite oxide. The composite oxide was confirmed to have a layered hexagonal crystal structure by verifying the obtained peak using the International Centre for Diffraction Data card (hereinafter referred to as “ICDD card”) (PDF-2). Accordingly, the composition of the composite oxide was found to be LiMn_{0.20}(Li_{0.04}Ni_{0.38}CO_{0.38})O₂. In addition, as a result of determination of the particle size distribution of the composite oxide, the average secondary particle size was found to be 5 μm.

Next, the step of surface treatment is described below.

The produced composite oxide was added to ion-exchange water (100 ml) containing aluminum nitrate (Al(NO₃)₃.9H₂O) (3.0 g) and lithium hydroxide (LiOH.H₂O) (1.0 g) dissolved therein, followed by stirring at ordinary temperature for 1 hour. Thus, the aluminum compound was allowed to adhere to the composite oxide surface. Next, ion-exchange water (100 ml) containing ammonium phosphate dibasic ((NH₄)₂HPO₄) (1.0 g) and lithium hydroxide (1.0 g) dissolved therein was added thereto, followed by stirring at ordinary temperature for 1 hour. Thus, the phosphate compound was allowed to adhere to the aluminum compound surface. Then, the obtained solution was dried by means of a spray dryer. The thus obtained powder was introduced into a high-purity alumina container and heated in the air at 650° C. for 5 hours.

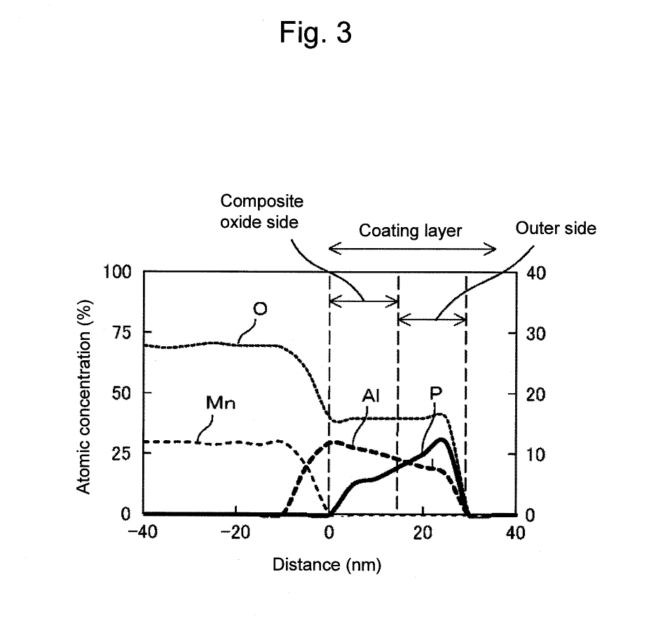

The obtained surface-modified composite oxide was subjected to pretreatment involving ion milling, followed by TEM observation. As a result, the coating layer thickness was found to be approximately 30 nm (see table 1 and FIG. 3). Further, FIG. 3 shows the results of line analysis of the distribution of major elements present in the vicinity of the coating layer.

In FIG. 3, the atomic concentrations of O (oxygen) and Mn+Ni+Co are substantially constant from a distance of −40 nm to a distance of 0 nm. Note that the interface between the composite oxide and the coating layer of the positive electrode corresponds to a distance of 0 nm This indicates the presence of the composite oxide from a distance of −40 nm to a distance of 0 nm.

In addition, the atomic concentration of Mn becomes 0 and the atomic concentration of O (oxygen) also decreases from a distance of 0 nm to a distance of 30 nm. Meanwhile, the atomic concentrations of P and Al are observed. This indicates the presence of the coating layer from a distance of 0 nm to a distance of 30 nm. The atomic concentration of P gradually increases from a distance of 0 nm to a distance of 30 nm. Specifically, the atomic concentration of P on the outer side (i.e., the electrolyte side) of the coating layer was found to be greater than that on the composite oxide side of such layer. The coating layer was divided into two sides (the outer side (i.e., the electrolyte side) and the composite oxide) at the center of thickness (at a distance of approximately 15 nm). Then, the mean atomic concentration of P on the outer side (i.e., the electrolyte) and that on the composite oxide were calculated. The former (on the outer side (i.e., the electrolyte side)) was found to be 9 atom % (see table 1) and the latter (on the composite oxide) was found to be 3 atom % (see table 1).

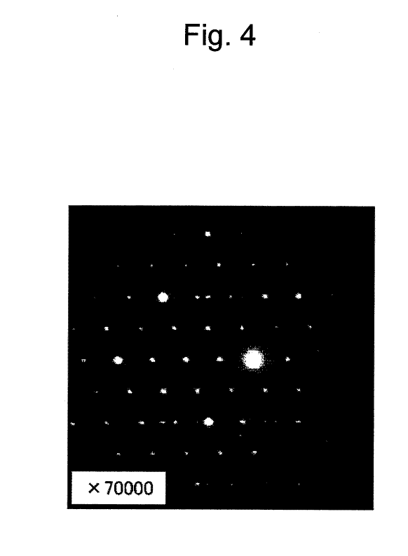

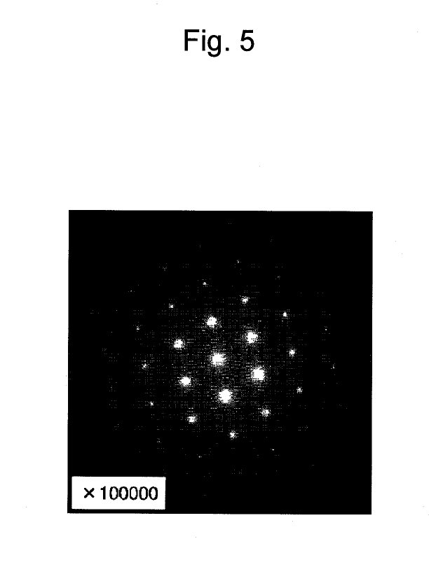

In addition, FIGS. 4 and 5 show electron diffraction images of compounds P and Al in the coating layer, respectively. These images were compared with electron diffraction images of known compounds P and Al based on the information contained in the database. It was found that the compounds P and Al correspond to Li₃PO₄ (ICDD: No. 15-760) and γ-Al₂O₃ (ICDD: No. 10-425), respectively.

In addition, ICP analysis of the surface-modified composite oxide was carried out. The proportions of P and Al in the coating of the composite oxide were calculated based on the information about Li₃PO₄ and γ-Al₂O₃ and found to be approximately 1.0% by weight and approximately 0.4% by weight, respectively (see table 1).

Next, production of a test battery is described below.

### (Production of a Positive Electrode for a Test Battery)

A positive electrode for a test battery was produced using the obtained surface-modified composite oxide. The composite oxide, a conductive carbon material and, and a solvent (N-methyl-2-pyrrolidinone (NMP)) containing a binder dissolved therein were mixed at a ratio of 85:10:5 (% by mass). The uniformly mixed slurry was applied to aluminum foil with a thickness of 20 μm serving as a current collector, followed by drying at 120° C. The resulting product was subjected to compression molding by a press so as to result in an electrode density of 2.7 g/cm³. After compression molding, the product was subjected punching using a punch to form disks with diameters of 15 mm Thus, a positive electrode for a test battery was produced.

### (Production of a Test Battery)

A test battery was produced using the produced positive electrode, metal lithium as a negative electrode, and a mixed solvent obtained as an electrolyte solution by mixing EC (ethylene carbonate), DMC (dimethyl carbonate), and VC (vinylene carbonate) with LiPF₆ (1 mol) serving as an electrolyte.

Exothermic peak evaluation using the above test battery is described below.

The exothermic peak of the positive electrode of the test battery was evaluated in the manner described below. The test battery was subjected to constant-current/constant-voltage charging at a charging rate of 0.5 C (at which 100% charging can be completed within 2 hours) to 4.2 V and then discharged at a constant current at a discharge rate of 0.5 C (at which 100% discharge can be completed within 2 hours) to a predetermined voltage.

One cycle of charging and discharge was repeated three times (3 cycles in total), followed by constant-current/constant-voltage charging at a charging rate of 0.5 C to 4.8 V. Then, the test battery was disassembled. The positive electrode was removed from the test battery and subjected to determination of exothermal behaviors using DSC. As a result, the exothermic peak was observed at 265° C. (see table 1).

### <Production of a 18650-Type Battery>

Production of a 18650-type (18 mm (diameter)×650 mm (height)) battery is described below.

A 18650-type battery was produced using the obtained positive electrode material. First, a composite oxide, a carbon material powder used as a conductive material, and PVDF (polyvinylidene difluoride) used as a binder were mixed at a weight ratio of 90:5:5. Slurry was prepared by adding an adequate amount of NMP (N-methylpyrrolidone) thereto.

The prepared slurry was stirred for 3 hours using a planetary mixer for kneading.

Next, the kneaded slurry was applied to both sides of aluminium foil with a thickness of 20 μm serving as a current collector for a positive electrode 1 using a coater such as a roll transcription machine. The resulting product was pressed using a roll press machine so as to result in a mixture density of 2.70 g/cm³. Thus, a positive electrode was obtained.

Subsequently, for production of a negative electrode 2, amorphous carbon used as a negative electrode active material, carbon black used as a conductive material, and PVDF used as a binder were mixed at a weight ratio of 92:2:6, followed by mixing using a slurry mixer for 30 minutes for kneading.

The kneaded slurry was applied to both sides of copper foil with a thickness of 10 μm serving as a current collector for a negative electrode 2 using a coater, followed by drying. Then, the resulting product was pressed using a roll press machine. Thus, a negative electrode was obtained.

The electrodes obtained as a positive electrode and a negative electrode were cut into predetermined sizes. A positive electrode lead 7 and a negative electrode lead 5 used as current-collecting tabs were welded by ultrasonic welding to a portion other than the slurry-coated portion on the positive electrode and such portion on the negative electrode, respectively.

A porous polyethylene film used as a separator 3 was sandwiched between the positive electrode 1 and the negative electrode 2. The resulting product was cylindrically (spirally) coiled and then inserted into a 18650-type battery can 4.

The positive electrode lead 7 serving as a current collecting tab was connected to a cover 6 of the battery can 4. The battery can 4 and the cover 6 of the battery can 4 were welded by laser welding so as to tightly seal the battery can.

Eventually, a non-aqueous electrolyte solution was introduced into the battery can 4 via a liquid inlet provided to the can. Thus, a 18650-type battery (lithium-ion secondary battery 10) was obtained.

Energy density evaluation is described below.

The energy density of the produced 18650-type battery was evaluated in the manner described below. Constant-current charging was carried out at a current of 0.5 C so as to achieve a charge cut-off voltage of 4.2 V. After a break of 1 hour, constant-current discharge was carried out at the same current so as to achieve 2.7 V. The discharge capacity was divided by the battery weight to calculate the energy density. The test environment temperature was 25° C. Table 2 shows the results.

TABLE 2

| Composite oxide | Energy density (Ah/kg) |
|---|---|
| Example 1 | 130 |

### Example 2

In Example 2, a composite oxide was produced as in the case of Example 1 except that a surface-modified composite oxide was produced by carrying out heat treatment in a nitrogen trifluoride gas (NF₃) atmosphere but not in the air after surface treatment.

In Example 2, the coating layer thickness was 30 nm. The mean concentration of P on the outer side (i.e., the electrolyte side) of the coating layer was found to be 9 atom % while the mean concentration of P on the composite oxide side of such layer was found to be 3 atom %. Electron diffraction images of the coating compounds containing P and Al in the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide were found to be 1.0% by weight and 0.4% by weight, respectively. In addition, the exothermic peak was found to be 275° C.

Table 3 shows properties of the composite oxide produced in Example 2.

TABLE 3

| | | | | | | Atomic | | | |
|---|---|---|---|---|---|---|---|---|---|
| | | | | | Atomic | concentration | | Proportion | |
| | | | | Coating | concentration | of P on the | Proportion | of | |
| | | | | layer | of P on the | composite | of Li₃PO₄ | Compound | |
| Composite | LiMn_{X}M_{1-X}O₂ | | | thickness | outer side | oxide side | (% by | M (% by | Exothermic |
| oxide | x | M | A | (nm) | (atom %) | (atom %) | weight) | weight) | peak (° C.) |
| Example 2 | 0.2 | Li, Ni, | Al | 30 | 9 | 3 | 1 | 0.4 | 275 |
| | | Co | | | | | | | |
| Example 3 | 0.2 | Li, Ni, | Al | 60 | 12 | 4 | 2 | 1 | 290 |
| | | Co | | | | | | | |
| Example 4 | 0.2 | Li, Ni, | Al | 50 | 8 | 4 | 1.2 | 0.8 | 260 |
| | | Co | | | | | | | |
| Example 5 | 0.4 | Li, Ni, | Cu | 60 | 12 | 4 | 2 | 1 | 280 |
| | | Co, Ti | | | | | | | |
| Example 6 | 0.33 | Li, Ni, | Al | 30 | 10 | 5 | 1.2 | 0.6 | 275 |
| | | Co, Mo | | | | | | | |
| Example 7 | 0.2 | Li, Ni, | Ti | 20 | 7 | 3 | 0.5 | 0.4 | 250 |
| | | Co, Mg | | | | | | | |
| Example 8 | 0.4 | Li, Ni, | Mg | 20 | 10 | 2 | 1 | 0.4 | 260 |
| | | Co, Al | | | | | | | |
| Example 9 | 0.2 | Li, Ni, | Al | 80 | 18 | 10 | 5 | 1.5 | 275 |
| | | Co | | | | | | | |
| Example | 0.2 | Li, Ni, | Al | 10 | 8 | 0 | 0.1 | 0.2 | 255 |
| 10 | | Co | | | | | | | |
| Example | 0.1 | Li, Ni, | Al | 20 | 10 | 5 | 0.6 | 0.4 | 250 |
| 11 | | Co, Mo | | | | | | | |
| Example | 0.6 | Li, Ni, | Al | 30 | 9 | 4 | 1 | 0.4 | 265 |
| 12 | | Co, Ti | | | | | | | |

As in the case of Example 1, a 18650-type battery was produced and the capacity maintenance rate was evaluated. Table 4 shows the results.

TABLE 4

| Composite oxide | Energy density (Ah/kg) |
|---|---|
| Example 2 | 129 |
| Example 3 | 128 |
| Example 4 | 130 |
| Example 5 | 136 |
| Example 6 | 128 |
| Example 7 | 132 |
| Example 8 | 127 |
| Example 9 | 126 |
| Example 10 | 131 |
| Example 11 | 138 |
| Example 12 | 125 |

A battery comprising the positive electrode produced in Example 2 was found to have an energy density of 129 Ah/kg. This indicates that the battery has high performance.

### Example 3

In Example 3, a composite oxide was produced as in the case of Example 1 except that a surface-modified composite oxide was produced using, as starting materials for surface treatment, magnesium nitrate (Mg(NO₃)₂) (7.5 g) and lithium hydroxide (2.5 g) instead of aluminum nitrate (3.0 g) and lithium hydroxide (1.0 g).

In Example 3, the coating layer thickness was 60 nm The mean concentration of P on the outer side (i.e., the electrolyte side) of the coating layer was found to be 12 atom % while the mean concentration of P on the composite oxide side of such layer was found to be 4 atom %. Electron diffraction images of the coating compounds containing P and Al and forming the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide were found to be 2.0% by weight and 1.0% by weight, respectively.

Table 3 shows properties of the composite oxide produced in Example 3.

In addition, the exothermic peak was found to be 290° C.

A 18650-type battery was produced as in the case of Example 1 and evaluated in terms of the capacity maintenance rate. Table 4 shows the results.

A battery comprising the positive electrode produced in Example 3 was found to have an energy density of 128 Ah/kg. This indicates that the battery has high performance.

### Example 4

In Example 4, a composite oxide (lithium-manganese composite oxide) was produced as in the case of Example 1 except that a surface-modified composite oxide was produced using, as starting materials for surface treatment, 6.0 g of aluminum nitrate and 2.0 g of lithium hydroxide instead of 3.0 g of aluminum nitrate and 1.0 g of lithium hydroxide, and 1.2 g of ammonium phosphate dibasic and 1.2 g of lithium hydroxide instead of 1.0 g of ammonium phosphate dibasic and 1.0 g of lithium hydroxide.

In Example 4, the coating layer thickness was 50 nm. The mean concentration of P on the outer side (i.e., the electrolyte side) of the coating layer was found to be 8 atom % while the mean concentration of P on the composite oxide side of such layer was found to be 4 atom %. Electron diffraction images of the coating compounds containing P and Al and forming the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide were found to be 1.2% by weight and 0.8% by weight, respectively.

Table 3 shows properties of the composite oxide produced in Example 4.

In addition, the exothermic peak was found to be 260° C.

A 18650-type battery was produced as in the case of Example 1 and evaluated in terms of the capacity maintenance rate. Table 4 shows the results.

A battery comprising the positive electrode produced in Example 4 was found to have an energy density of 130 Ah/kg. This indicates that the battery has high performance.

### Example 5

In Example 5, a composite oxide was produced as in the case of Example 1 except that titanium oxide (TiO₂) was used as a starting material for a composite oxide, in addition to the starting materials used in Example 1, and the starting materials were weighed at a ratio of Li:Mn:Ni:Co:Ti of 1.04:0.40:0.25:0.25:0.06. Then, a surface-modified composite oxide was produced using, as starting materials for surface treatment, 3.0 g of copper(II) nitrate (Cu(NO₃)₂) and 2.0 g of lithium hydroxide instead of 3.0 g of aluminum nitrate and 1.0 g of lithium hydroxide, and 2.5 g of ammonium phosphate dibasic and 2.5 g of lithium hydroxide instead of 1.0 g of ammonium phosphate dibasic and 1.0 g of lithium hydroxide.

In Example 5, the coating layer thickness was 60 nm The mean concentration of P on the outer side (i.e., the electrolyte side) of the coating layer was found to be 12 atom % while the mean concentration of P on the composite oxide side of such layer was found to be 4 atom %. Electron diffraction images of the coating compounds containing P and Cu and forming the coating layer corresponded to Li₃PO₄ (ICDD: No. 15-760) and CuO (ICDD NO. 5-661), respectively. As a result of calculation by ICP analysis of the surface-modified composite oxide, the proportions of the compounds P and Cu of the coating layer relative to the proportion of the composite oxide were found to be 2.0% by weight and 1.0% by weight, respectively.

Table 3 shows properties of the composite oxide produced in Example 5.

In addition, the exothermic peak was found to be 280° C.

A 18650-type battery was produced as in the case of Example 1 and evaluated in terms of the capacity maintenance rate. Table 4 shows the results.

A battery comprising the positive electrode produced in Example 5 was found to have an energy density of 136 Ah/kg. This indicates that the battery has high performance.

### Example 6

In Example 6, a composite oxide was produced as in the case of Example 1 except that molybdenum oxide (W₂O₅) was used as a starting material for a composite oxide, in addition to the starting materials used in Example 1, and the starting materials were weighed at a ratio of Li:Mn:Ni:Co:W of 1.04:0.33:0.30:0.30:0.03. Then, a surface-modified composite oxide was produced using, as starting materials for surface treatment, 3.6 g of aluminum nitrate and 1.5 g of lithium hydroxide instead of 3.0 g of aluminum nitrate and 1.0 g of lithium hydroxide, and 1.5 g of ammonium phosphate dibasic and 1.5 g of lithium hydroxide instead of 1.0 g of ammonium phosphate dibasic and 1.0 g of lithium hydroxide.

In Example 6, the coating layer thickness was 30 nm. The mean concentration of P on the outer side (i.e., the electrolyte side) of the coating layer was found to be 10 atom % while the mean concentration of P on the composite oxide side of such layer was found to be 5 atom %. Electron diffraction images of the coating compounds containing P and Al and forming the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide were found to be 1.2% by weight and 0.6% by weight, respectively.

Table 3 shows properties of the composite oxide in Example 6.

In addition, the exothermic peak was found to be 275° C.

A 18650-type battery was produced as in the case of Example 1 and evaluated in terms of the capacity maintenance rate. Table 4 shows the results.

A battery comprising the positive electrode produced in Example 6 was found to have an energy density of 128 Ah/kg. This indicates that the battery has high performance.

### Example 7

In Example 7, a composite oxide was produced as in the case of Example 1 except that magnesium oxide (MgO) was used as a starting material for a composite oxide, in addition to the starting materials used in Example 1, and the starting materials were weighed at a ratio of Li:Mn:Ni:Co:Mg of 1.04:0.20:0.32:0.32:0.02. Then, a surface-modified composite oxide was produced using, as starting materials for, surface treatment, 2.2 g of titanyl sulfate (TiOSO₄) and 0.8 g lithium hydroxide instead of 3.0 g of aluminum nitrate and 1.0 g of lithium hydroxide, and 0.5 g of ammonium phosphate dibasic and 0.5 g of lithium hydroxide instead of 1.0 g of ammonium phosphate dibasic and 1.0 g of lithium hydroxide.

In Example 7, the coating layer thickness was 20 nm. The mean concentration of P on the outer side (i.e., the electrolyte side) of the coating layer was found to be 7 atom % while the mean concentration of P on the composite oxide side of such layer was found to be 3 atom %. Electron diffraction images of the coating compounds containing P and Ti and forming the coating layer corresponded to Li₃PO₄ (ICDD: No. 15-760) and TiO₂ (ICDD: No. 21-1272), respectively. As a result of calculation by ICP analysis of the surface-modified composite oxide, the proportions of the compounds P and Ti in the coating layer relative to the proportion of the composite oxide were found to be 0.5% by weight and 0.4% by weight, respectively.

Table 3 shows properties of the composite oxide produced in Example 7.

In addition, the exothermic peak was found to be 250° C.

A 18650-type battery was produced as in the case of Example 1 and evaluated in terms of the capacity maintenance rate. Table 4 shows the results.

A battery comprising the positive electrode produced in Example 7 was found to have an energy density of 132 Ah/kg. This indicates that the battery has high performance.

### Example 8

In Example 8, a composite oxide was produced as in the case of Example 1 except that aluminum oxide (Al₂O₃) was used as a starting material for a composite oxide, in addition to the starting materials used in Example 1, and the starting materials were weighed at a ratio of Li:Mn:Ni:Co:Al of 1.04:0.40:0.25:0.25:0.06. Then, a surface-modified composite oxide was produced using, as a starting material for surface treatment, 3.0 g of magnesium nitrate (Mg(NO₃)₂) instead of 3.0 g of aluminum nitrate.

In Example 8, the coating layer thickness was 20 nm. The mean concentration of P on the outer side (i.e., the electrolyte side) of the coating layer was found to be 10 atom % while the mean concentration of P on the composite oxide side of such layer was found to be 2 atom %. Electron diffraction images of the coating compounds containing P and Mg and forming the coating layer corresponded to Li₃PO₄ (ICDD: No. 15-760) and MgO (ICDD: No. 45-946), respectively. As a result of calculation by ICP analysis of the surface-modified composite oxide, the proportions of the compounds P and Mg of the coating layer relative to the proportion of the composite oxide were found to be 1.0% by weight and 0.4% by weight, respectively.

Table 3 shows properties of the composite oxide produced in Example 8.

In addition, the exothermic peak was found to be 260° C.

A 18650-type battery was produced as in the case of Example 1 and evaluated in terms of the capacity maintenance rate. Table 4 shows the results.

A battery comprising the positive electrode produced in Example 8 was found to have an energy density of 127 Ah/kg. This indicates that the battery has high performance.

### Example 9

In Example 9, a composite oxide was produced as in the case of Example 1. A surface-modified composite oxide was produced, using as starting materials for surface treatment, 11.2 g of aluminum nitrate and 3.8 g of lithium hydroxide instead of 3.0 g of aluminum nitrate and 1.0 g of lithium hydroxide, and 5.0 g of ammonium phosphate dibasic and 5.0 g of lithium hydroxide instead of 1.0 g of ammonium phosphate dibasic and 1.0 g of lithium hydroxide.

In Example 9, the coating layer thickness was 80 nm. The mean concentration of P on the outer side (i.e., the electrolyte side) of the coating layer was found to be 18 atom % while the mean concentration of P on the composite oxide side of such layer was found to be 10 atom %. Electron diffraction images of the coating compounds containing P and Al and forming the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al of the coating layer relative to the proportion of the composite oxide were found to be 5.0% by weight and 1.5% by weight, respectively.

Table 3 shows properties of the composite oxide produced in Example 9.

In addition, the exothermic peak was found to be 275° C.

A 18650-type battery was produced as in the case of Example 1 and evaluated in terms of the capacity maintenance rate. Table 4 shows the results.

A battery comprising the positive electrode produced in Example 9 was found to have an energy density of 126 Ah/kg. This indicates that the battery has high performance.

### Example 10

In Example 10, a composite oxide was produced as in the case of Example 1. A surface-modified composite oxide was produced, using as starting materials for surface treatment, 1.5 g of aluminum nitrate and 0.5 g of lithium hydroxide instead of 3.0 g of aluminum nitrate and 1.0 g of lithium hydroxide, and 0.1 g of ammonium phosphate dibasic and 0.1 g of lithium hydroxide instead of 1.0 g of ammonium phosphate dibasic and 1.0 g of lithium hydroxide.

In Example 10, the coating layer thickness was 10 nm. The mean concentration of P on the outer side (i.e., the electrolyte side) of the coating layer was found to be 8 atom % while the mean concentration of P on the composite oxide side of such layer was found to be 0 atom %. Electron diffraction images of the coating compounds containing P and Al that formed the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide were found to be 0.1% by weight and 0.2% by weight, respectively.

Table 3 shows properties of the composite oxide produced in Example 10.

In addition, the exothermic peak was found to be 255° C.

A 18650-type battery was produced as in the case of Example 1 and evaluated in terms of the capacity maintenance rate. Table 4 shows the results.

A battery comprising the positive electrode produced in Example 10 was found to have an energy density of 131 Ah/kg. This indicates that the battery has high performance.

### Example 11

In Example 11, a composite oxide was produced as in the case of Example 1 except that molybdenum oxide was used as a starting material for a composite oxide, in addition to the starting materials used in Example 1, and the starting materials were weighed at a ratio of Li:Mn:Ni:Co:W of 1.04:0.10:0.42:0.42:0.02. Then, a surface-modified composite oxide was produced using, as starting materials for surface treatment, 0.6 g of ammonium phosphate dibasic and 0.6 g of lithium hydroxide instead of 1.0 g of ammonium phosphate dibasic and 1.0 g of lithium hydroxide.

In Example 11, the coating layer thickness was 20 nm. The mean concentration of P on the outer side (i.e., the electrolyte side) of the coating layer was found to be 10 atom % while the mean concentration of P on the composite oxide side of such layer was found to be 5 atom %. Electron diffraction images of the coating compounds containing P and Al and forming the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide were found to be 0.6% by weight and 0.4% by weight, respectively.

Table 3 shows properties of the composite oxide produced in Example 11.

In addition, the exothermic peak was 250° C.

A 18650-type battery was produced as in the case of Example 1 and evaluated in terms of the capacity maintenance rate. Table 4 shows the results.

A battery comprising the positive electrode produced in Example 11 was found to have an energy density of 127 Ah/kg. This indicates that the battery has high performance.

### Example 12

In Example 12, the composite oxide was produced as in the case of Example 1 except that titanium oxide was used as a starting material for a composite oxide, in addition to the starting materials used in Example 1, and the starting materials were weighed at a ratio of Li:Mn:Ni:Co:Ti of 1.04:0.60:0.16:0.16:0.04. Then, a surface-modified composite oxide was produced as in the case of Example 1.

In Example 12, the coating layer thickness was 30 nm. The mean concentration of P on the outer side (i.e., the electrolyte side) of the coating layer was found to be 9 atom % while the mean concentration of P on the composite oxide side of such layer was found to be 4 atom %. Electron diffraction images of the coating compounds containing P and Al and forming the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide were found to be 1.0% by weight and 0.4% by weight, respectively.

Table 3 shows properties of the composite oxide produced in Example 12.

In addition, the exothermic peak was found to be 265° C.

A 18650-type battery was produced as in the case of Example 1 and evaluated in terms of the capacity maintenance rate. Table 4 shows the results.

A battery comprising the positive electrode produced in Example 12 was found to have an energy density of 125 Ah/kg. This indicates that the battery has high performance.

### Comparative Example 1

In Comparative Example 1, an oxide or fluoride containing A (where A denotes at least one element selected from the group consisting of Mg, Al, Ti, and Cu) serving as a coating compound was not used to form a coating layer for comparison with Examples 1 to 12.

In Comparative Example 1, a composite oxide was produced as in the case of Example 1.

Next, surface treatment was carried out to form a coating layer by adding the produced composite oxide (100 g) to ion-exchange water (100 ml) containing ammonium phosphate dibasic (1.0 g) and lithium hydroxide (1.0 g) dissolved therein, stirring the resultant at ordinary temperature for 1 hour, and thereby allowing the phosphate compound to adhere to the composite oxide surface. The obtained powder was subjected to heat treatment in the air at 650° C. for 5 hours. Thus, a surface-modified composite oxide was produced.

In Comparative Example 1, the coating layer thickness was 10 nm. The mean concentration of P on the outer side (i.e., the electrolyte side) of the coating layer was found to be 12 atom % while the mean concentration of P on the composite oxide side of such layer was found to be 11 atom %. An electron diffraction image of the coating compound containing P and forming the coating layer corresponded to Li₃PO₄ (ICDD: No. 15-760). As a result of calculation by ICP analysis of the surface-modified composite oxide, the proportion of the compound P in the coating layer relative to that of the composite oxide was found to be 1.0% by weight.

Table 5 shows properties of the composite oxide produced in Comparative Example 1.

TABLE 5

| | | | | | | Atomic | | | |
|---|---|---|---|---|---|---|---|---|---|
| | | | | | Atomic | concentration | | Proportion | |
| | | | | Coating | concentration | of P on the | Proportion | of | |
| | | | | layer | of P on the | composite | of Li₃PO₄ | Compound | |
| Composite | LiMn_{X}M_{1-X}O₂ | | | thickness | outer side | oxide side | (% by | M (% by | Exothermic |
| oxide | x | M | A | (nm) | (atom %) | (atom %) | weight) | weight) | peak (° C.) |
| Comparative | 0.2 | Li, Ni, | — | 10 | 12 | 11 | 1 | 0 | 220 |
| Example 1 | | Co | | | | | | | |
| Comparative | 0.2 | Li, Ni, | Al | 20 | 0 | 0 | 0 | 0.4 | 210 |
| Example 2 | | Co | | | | | | | |
| Comparative | 0.2 | Li, Ni, | Al | 30 | 8 | 9 | 1 | 0.4 | 225 |
| Example 3 | | Co | | | | | | | |
| Comparative | 0.2 | Li, Ni, | Al | 20 | 2 | 10 | 1 | 0.4 | 220 |
| Example 4 | | Co | | | | | | | |

In addition, the exothermic peak was found to be 220° C. In Comparative Example 1, the exothermic peak decreased below the exothermic peaks obtained in Examples 1 to 12 (exothermic peak 250° C.-290° C. (see tables 1 and 3)). This is probably because that the absence of the metal (A) compound in the coating layer caused nonuniform distribution of the phosphate compound, resulting in reduction of heat generation inhibition effects.

A 18650-type battery was produced as in the case of Example 1 and evaluated in terms of the capacity maintenance rate. Table 6 shows the results.

TABLE 6

| Composite oxide | Energy density (Ah/kg) |
|---|---|
| Comparative Example 1 | 130 |
| Comparative Example 2 | 125 |
| Comparative Example 3 | 128 |
| Comparative Example 4 | 126 |

The energy density obtained in Comparative Example 1 is 130 Ah/kg in table 6. Meanwhile, the energy density obtained in Example 1 is 130 Ah/kg in table 2. The energy densities obtained in Examples 2 to 12 are 125-136 Ah/kg in table 4.

Accordingly, the energy density of a battery comprising a positive electrode produced in any one of Examples 1 to 12 was found to be maintained at a substantially constant level compared with that of a battery comprising the positive electrode produced in Comparative Example 1.

### Comparative Example 2

In Comparative Example 2, a phosphate compound was not used to form a coating layer for comparison with Examples 1 to 12.

In Comparative Example 2, the composite oxide was produced as in the case of Example 1.

Next, surface treatment was carried out to form a coating layer by adding the produced composite oxide (100 g) to ion-exchange water (100 ml) containing aluminum nitrate (3.0 g) and lithium hydroxide (1.0 g) dissolved therein, stirring the resultant at ordinary temperature for 1 hour, and thereby allowing the phosphate compound to adhere to the composite oxide surface. The obtained powder was subjected to heat treatment in the air at 650° C. for 5 hours. Thus, a surface-modified composite oxide was produced.

In Comparative Example 2, the coating layer thickness was 20 nm. The mean concentration of P on the outer side (i.e., the electrolyte side) of the coating layer and that on the composite oxide side of such layer were found to be 0 atom % because of the absence of P in the coating layer. An electron diffraction image of the coating compound containing Al and forming the coating layer corresponded to γ-Al₂O₃ (ICDD: No. 10-425). As a result of calculation by ICP analysis of the surface-modified composite oxide, the proportion of the compound Al in the coating layer relative to that of the composite oxide was found to be 0.4% by weight.

Table 5 shows properties of the composite oxide produced in Comparative Example 2.

In addition, the exothermic peak was found to be 210° C. In Comparative Example 2, the exothermic peak decreased below the exothermic peaks obtained in Examples 1 to 12 (exothermic peak: 250° C.-290° C. (see tables 1 and 3)). This is probably because that the absence of the phosphate compound resulted in reduction of heat generation inhibition effects.

A 18650-type battery was produced as in the case of Example 1 and evaluated in terms of the capacity maintenance rate. Table 6 shows the results.

The energy density obtained in Comparative Example 2 is 125 Ah/kg in table 6. Meanwhile, the energy density obtained in Example 1 is 130 Ah/kg in table 2. The energy densities obtained in Examples 2 to 12 are 125-136 Ah/kg in table 4.

Accordingly, the energy density of a battery comprising a positive electrode produced in any one of Examples 1 to 12 was found to be maintained at a substantially constant level compared with that of a battery comprising the positive electrode produced in Comparative Example 2.

### Comparative Example 3

In Comparative Example 3, no gradient of the concentration of the phosphate compound P forming the coating layer was created from the outer side (i.e., the electrolyte side) of the coating layer to the composite oxide side of such layer for comparison with Examples 1 to 12 in which a gradient of the concentration of P in the coating layer was created (provided that the concentration of P on the outer side (i.e., the electrolyte side) was high and that on the composite oxide was low).

In Comparative Example 3, a composite oxide was produced as in the case of Example 1.

Next, surface treatment was carried out to form a coating layer by adding ion-exchange water (100 ml) containing ammonium phosphate dibasic (1.0 g) and lithium hydroxide (1.0 g) dissolved therein to ion-exchange water (100 ml) containing aluminum nitrate (3.0 g) and lithium hydroxide (1.0 g) dissolved therein, stirring the resultant at ordinary temperature for 1 hour, introducing the produced composite oxide (100 g) thereinto, stirring the resultant at ordinary temperature for 1 hour, and thereby allowing the phosphate compound and the aluminum compound to adhere to the composite oxide surface. The obtained powder was subjected to heat treatment in the air at 650° C. for 5 hours. Thus, a surface-modified composite oxide was produced.

In Comparative Example 3, the coating layer thickness was 30 nm. The mean concentration of P on the outer side (i.e., the electrolyte side) of the coating layer was found to be 8 atom % while the mean concentration of P on the composite oxide side of such layer was found to be 9 atom %. Electron diffraction images of the coating compounds containing P and Al for the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide was found to be 1.0% by weight and 0.4% by weight, respectively.

Table 5 shows properties of the composite oxide produced in Comparative Example 3.

In addition, the exothermic peak was found to be 225° C. In Comparative Example 3, the exothermic peak decreased below the exothermic peaks obtained in Examples 1 to 12 (exothermic peak: 250° C.-290° C. (see tables 1 and 3)). This is probably because that uniform distribution of the phosphate compound in the coating layer caused insufficient inhibition of degradation of the electrolyte solution on the outer side (i.e., the electrolyte side), resulting in reduction of heat generation inhibition effects.

A 18650-type battery was produced as in the case of Example 1 and evaluated in terms of the capacity maintenance rate. Table 6 shows the results.

The energy density obtained in Comparative Example 3 is 128 Ah/kg in table 6. Meanwhile, the energy density obtained in Example 1 is 130 Ah/kg in table 2. The energy densities obtained in Examples 2 to 12 are 125-136 Ah/kg in table 4.

Accordingly, the energy density of a battery comprising a positive electrode produced in any one of Examples 1 to 12 was found to be maintained at a substantially constant level compared with that of a battery comprising the positive electrode produced in Comparative Example 3.

### Comparative Example 4

In Comparative Example 4, the concentration of the phosphate compound forming the coating layer was decreased on the outer side (i.e., the electrolyte side) of the coating layer and that on the composite oxide side was increased. In Examples 1 to 12, the concentration of P on the outer side (i.e., the electrolyte side) of the coating layer was high and the concentration on the composite oxide side was low. Thus, the gradient of the concentration of P created in the Examples and a reverse gradient thereof created in Comparative Example 4 were compared with each other.

In Comparative Example 4, the composite oxide was produced as in the case of Example 1.

Next, surface treatment was carried out to form a coating layer by adding the produced composite oxide to ion-exchange water (100 ml) containing ammonium phosphate dibasic (1.0 g) and lithium hydroxide (1.0 g) dissolved therein, stirring the resultant at ordinary temperature for 1 hour, and thereby allowing the phosphate compound to adhere to the composite oxide surface. Then, ion-exchange water (100 ml) containing aluminum nitrate (3.0 g) and lithium hydroxide (1.0 g) dissolved therein was added thereto, followed by another instance of stirring for 1 hour at ordinary temperature. The obtained powder was subjected to heat treatment in the air at 650° C. for 5 hours. Thus, a surface-modified composite oxide was produced.

In Comparative Example 4, the coating layer thickness was 20 nm. The mean concentration of P on the outer side (i.e., the electrolyte side) of the coating layer was found to be 2 atom % while the mean concentration of P on the composite oxide side of such layer was found to be 10 atom %. Electron diffraction images of the coating compounds containing P and Al for the coating layer corresponded to Li₃PO₄ (ICDD: No. 15-760) and γ-Al₂O₃ (ICDD: No. 10-425), respectively. As a result of calculation by ICP analysis of the surface-modified composite oxide, the proportions of the compounds P and Al in the coating layer relative to the proportion of the composite oxide was found to be 1.0% by weight and 0.4% by weight, respectively.

Table 5 shows properties of the composite oxide produced in Comparative Example 4.

In addition, the exothermic peak was found to be 220° C. In Comparative Example 4, the exothermic peak decreased below the exothermic peaks obtained in Examples 1 to 12 (exothermic peak: 250° C.-290° C. (see tables 1 and 3)). This is probably because distribution of the phosphate compound in the coating layer increased on the composite oxide side and thus inhibition of degradation of the electrolyte solution was not sufficiently achieved on the outer side (i.e., the electrolyte side), resulting in reduction of heat generation inhibition effects.

A 18650-type battery was produced as in the case of Example 1 and evaluated in terms of the capacity maintenance rate. Table 6 shows the results.

The energy density obtained in Comparative Example 4 is 126 Ah/kg in table 6. Meanwhile, the energy density obtained in Example 1 is 130 Ah/kg in table 2. The energy densities obtained in Examples 2 to 12 are 125-136 Ah/kg in table 4.

Accordingly, the energy density of a battery comprising a positive electrode produced in any one of Examples 1 to 12 was found to be maintained at a substantially constant level compared with that of a battery comprising the positive electrode produced in Comparative Example 4.

### <Effects>

In view of the above, according to the embodiments of the present invention, a positive electrode material for a lithium-ion secondary battery is provided, which is characterized in that a coating layer comprising a phosphate compound and an oxide or fluoride containing A (where A denotes at least one element selected from the group consisting of Mg, Al, Ti, and Cu) is formed on the surface of a lithium-manganese composite oxide, and the atomic concentration of P on the outer side (i.e., the electrolyte side) of the coating layer is greater than that on the lithium-manganese composite oxide side of such layer. With the use of such positive electrode material for a lithium-ion secondary battery, a lithium-ion secondary battery, which is excellent in terms of safety and in which heat generation due to a temperature increase upon charging is inhibited, can be provided.

For such lithium-ion secondary battery, high degrees of safety can be ensured particularly during charging.

### Example 13

### Secondary Battery System 10S Equipped with Lithium-Ion Secondary Batteries 10

Next, in Example 13, a secondary battery system 10S equipped with lithium-ion secondary batteries 10 is described.

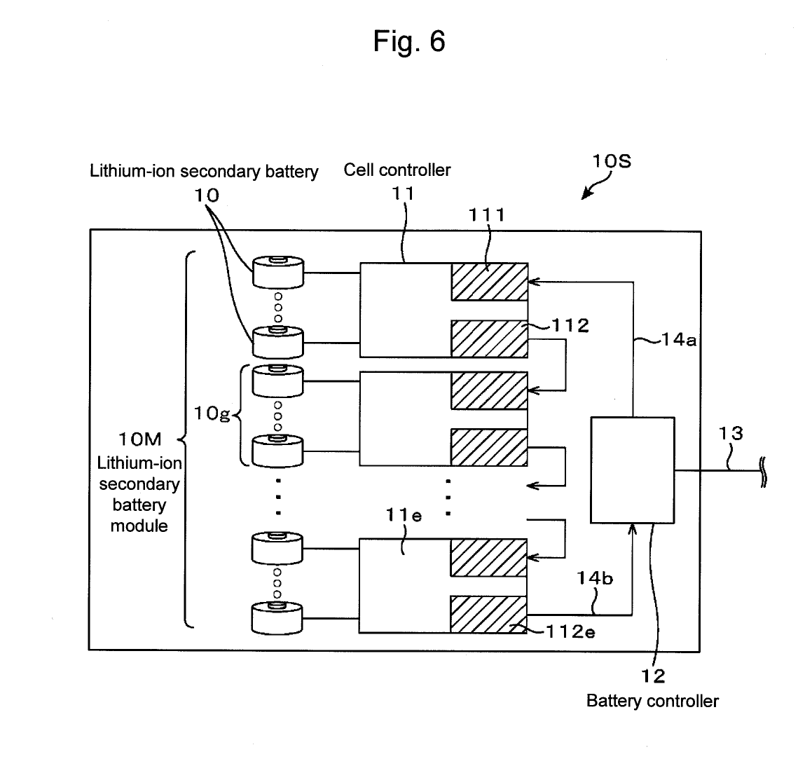

FIG. 6 schematically shows the outline of a secondary battery system 10S equipped with lithium-ion secondary batteries 10 produced in this Example.

For example, 4 to 10 lithium-ion secondary batteries 10 are connected in series to form a lithium-ion secondary battery group 10g for a lithium-ion secondary battery 10. In addition, a secondary battery module 10M is configured using a plurality of lithium-ion secondary battery groups 10g. Here, the number of lithium-ion secondary batteries 10 consisting of a lithium-ion secondary battery group 10g can be adequately selected.

A secondary battery module 10M has a cell controller 11. The cell controller 11 is formed for each lithium-ion secondary battery group 10g so as to control each lithium-ion secondary battery 10. The cell controller 11 detects inter-terminal voltages of lithium-ion secondary batteries 10 and monitors excessive charging or discharge of each lithium-ion secondary battery 10 and the residual capacity of each lithium-ion secondary battery 10 so as to regulate each lithium-ion secondary battery 10.

A battery controller 12 transmits signals to a cell controller 11 by, for example, a communication means 14a and receives signals from a cell controller 11 by, for example, a communication means 14b in a simultaneous manner. In addition, the battery controller 12 is connected with the outside via a signal line 13.

The battery controller 12 regulates electric power input into and output from the cell controller 11.

The battery controller 12 transmits signals to, for example, an input unit 111 of a first cell controller 11. The signals are continuously transmitted from an output unit 112 of the cell controller 11 to an input unit 111 of a different cell controller 11. Then, the signals are transmitted from an output unit 112e of the last cell controller 11e to the battery controller 12.

Accordingly, the battery controller 12 is allowed to monitor (supervise) the cell controller 11. In addition, the cell controller 11 and the battery controller 12 are adequately configured using a computer, a circuit, or the like. However, there is no limitation.

In addition, FIG. 6 shows an example in which lithium-ion secondary batteries 10 are connected in series. However, they may be connected in parallel to increase capacity. Alternatively, it is also possible to use a combination of lithium-ion secondary batteries 10 connected in series and those connected in parallel. As long as, lithium-ion secondary batteries 10 are electrically connected to each other. The form of connection is not limited and adequately selected.

### DESCRIPTION OF SYMBOLS

1: Positive electrode
2: Negative electrode
3: Separator
4: Battery can
10: Lithium-ion secondary battery (battery)
10M: Secondary battery module
10S: Secondary battery system
11: Cell controller (controller)
12: Battery controller
111: Input unit
112, 112e: Output unit

What is claimed is:

1. A positive electrode material for a lithium-ion secondary battery, which comprises a layered lithium-manganese composite oxide represented by the following composition formula: LiMnₓM₁₋ₓO₂ (where 0.1≦x≦0.6 and M denotes at least one element selected from the group consisting of Li, Mg, Al, Ti, Co, Ni, and Mo), wherein
a coating layer comprising a phosphate compound and an oxide or fluoride containing A (where A denotes at least one element selected from the group consisting of Mg, Al, Ti, and Cu) is formed on the surface of the lithium-manganese composite oxide, and
the atomic concentration of phosphorus on the outer side of the coating layer is greater than that on the lithium-manganese composite oxide side of the coating layer.

2. The positive electrode material for a lithium-ion secondary battery according to claim 1, wherein
the mean value of the atomic concentration of phosphorus on the outer side (i.e., the electrolyte side) of the coating layer is greater by at least 4 atom % than the mean value of the atomic concentration of phosphorus on the composite oxide side of the coating layer when the coating layer is divided into two sides at the center of the thickness of the layer.

3. The positive electrode material for a lithium-ion secondary battery according to claim 1, wherein the phosphate compound is at least one member selected from the group consisting of Li₃PO₄, Li₄P₂O₇, and LiPO₃.

4. The positive electrode material for a lithium-ion secondary battery according to claim 1, wherein the atomic concentration of A in the oxide or fluoride containing A on the lithium-manganese composite oxide side of the coating layer is greater than that on the electrolyte side of the coating layer.

5. The positive electrode material for a lithium-ion secondary battery according to claim 1, wherein the content of the phosphate compound is 0.1% by weight to 5.0% by weight when the content of the lithium-manganese composite oxide is 100% by weight.

6. The positive electrode material for a lithium-ion secondary battery according to claim 1, wherein the content of the oxide or fluoride containing M is 0.2% by weight to 1.5% by weight when the content of the lithium-manganese composite oxide is 100% by weight.

7. The positive electrode material for a lithium-ion secondary battery according to claim 1, wherein the thickness of the coating layer is 2 nm to 80 nm.

8. A lithium-ion secondary battery, which comprises the positive electrode material for a lithium-ion secondary battery according to claim 1.

9. The lithium-ion secondary battery according to claim 8, wherein, when the positive electrode charged to 4.8 V by a Li counter electrode is heated, the main exothermic peak becomes 230° C. or higher.

10. A secondary battery module, which comprises a plurality of electrically connected lithium-ion secondary batteries according to claim 8 and a controller for detecting inter-terminal voltages of and controlling conditions of the plurality of lithium-ion secondary batteries.

11. A lithium-ion secondary battery module, which is a secondary battery module comprising a plurality of electrically connected batteries and a controller for regulating and controlling conditions of the plurality of batteries, wherein:
the controller detects inter-terminal voltages of the plurality of batteries;
each battery is composed of at least one laminate having a positive electrode, a negative electrode, and an electrolyte housed in a battery can serving as an exterior package of the battery;
the positive electrode comprises a layered lithium-manganese composite oxide, on the surface of which a coating layer comprising a phosphate compound and an oxide or fluoride containing A (where A denotes at least one element selected from the group consisting of Mg, Al, Ti, and Cu) is formed, the layered lithium-manganese composite oxide being represented by the following formula: LiMnₓM₁₋ₓO₂ (where 0.1≦x≦0.6 and M denotes at least one element selected from the group consisting of Li, Mg, Al, Ti, Co, Ni, and Mo); and
the atomic concentration of phosphorus on the outer side of the coating layer is greater than that on the lithium-manganese composite oxide side of the coating layer.

12. The secondary battery module according to claim 11, wherein the atomic concentration of phosphorus in the phosphate compound on the outer side (i.e., the electrolyte side) of the coating layer is greater than that on the lithium-manganese composite oxide side of the coating layer.
